(19) United States
(12) Patent Application Publication
(10) Pub. No.: US 2007/0049649 A1
(43) Pub. Date: Mar. 1, 2007

(54) Method of Making Foamed Polymer Beads

(76) Inventors: Mao-Song Lee, Jen Te Hsian, Tainan County (TW); Hsi-Hsin Shih, Jen Te Hsian, Tainan County (TW); Shih-Kai Cheng, Jen Te Hsian, Tainan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/468,360

(22) Filed: Aug. 30, 2006

(30) Foreign Application Priority Data
Aug. 31, 2005 (TW) 94129962

(51) Int. Cl. C08J 9/28

(52) U.S. Cl. 521/64

(57) ABSTRACT

Disclosed is a method of making foamed polymer beads, which comprises: mixing a polymer with a high-pressure gas or a supercritical fluid in an extruder to create a homogeneous single-phase mixture; and extruding the homogeneous single-phase mixture through a die to granulate foamed polymer beads each containing micro voids inside.

### RELATED APPLICATIONS

The present application is based on, and claims priority from, Taiwan Application Serial Number 94129962, filed Aug. 31, 2005, the disclosure of which is hereby incorporated by reference herein in its entirety.

### FIELD OF THE INVENTION

This invention relates generally to a method of making foamed polymer beads, and more particularly, to a method of making foamed polymer beads by using a continuous process.

### BACKGROUND OF THE INVENTION

Polymer foam is widely applied in building materials, acoustic materials, heat insulating materials, filling materials, and packaging materials, due to its good chemical and heat resistances, and its excellent cushion as well. The polymer foam sheet is typically formed by hot pressing expandable polymer beads, for example, expandable polystyrene (EPS) beads, in a heated mold.

Conventional foamed polymer beads are typically produced as follows. Polymer pellets and a high-pressure gas or a supercritical fluid are loaded into a batch-type reaction vessel for immersing. And then, the pressure and temperature in the reaction vessel are lowered for expanding the polymer pellets into foamed polymer beads. According to the conventionally aforementioned method of making foamed polymer beads, while dealing different lots of the processes, it must be respectively carrying out the individual step of increasing pressure and temperature (i.e. the immersing step) and the individual step of lowering pressure and temperature in the reaction vessel (i.e. the expansion step), so that the resultant production efficiency is relatively low and the throughput is constrained.

### SUMMARY OF THE INVENTION

Accordingly, an aspect of the present invention provides a method of making foamed polymer beads by using a continuous process, for effectively enhancing the production efficiency and throughput.

According to the aforementioned aspect of the present invention, a method of making foamed polymer beads is provided, which comprises steps as follows. A polymer is mixed with a high-pressure gas or a supercritical fluid to create a homogeneous single-phase mixture in an extruder (i.e. the immersing step). And then, the homogeneous single-phase mixture is extruded through a die to granulate foamed polymer beads each containing micro voids inside (i.e. the foaming step). Preferably, the micro voids have a mean cell diameter of no more than 200 μm, and the foamed polymer beads have a specific gravity of no more than 0.5.

In comparison with the conventionally batch-type process of foamed polymer beads, the present method is to produce foamed polymer beads by using a continuous process, that is to say, it is simultaneously carrying out the immersing and foaming steps in the same extruder but in different segments thereof, thereby increasing the production efficiency and throughput efficiently.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawing, wherein:

FIG. 1 illustrates a scanning electron microscopy image showing the resultant foamed polypropylene beads in accordance with a preferred embodiment of the present invention.

### DETAILED DESCRIPTION OF THE PREFERRED EMBODIMENT

The present invention provides a method of making foamed polymer beads, which mainly includes following steps. A polymer is mixed with a high-pressure gas or a supercritical fluid in an extruder to create a homogeneous single-phase mixture (i.e. the immersing step). And then, the homogeneous single-phase mixture is extruded through a die to granulate foamed polymer beads each containing micro voids inside (i.e. the foaming step). Preferably, the micro voids have a mean cell diameter of no more than 200 μm, and the foamed polymer beads have a specific gravity of no more than 0.5.

The appropriate polymer may be polyolefin, polyolefin copolymer, cyclic olefin, cyclic olefin copolymer, polystyrene, polystyrene copolymer, acrylic resin, polycarbonate or mixtures thereof. Moreover, the appropriate extruder may be a single-screw extruder, a tandem extruder or a twin-screw extruder. Furthermore, the appropriate high-pressure gas may be carbon dioxide, nitrogen gas, hydrocarbon compounds, chlorofluorocarbon compounds or mixtures thereof. Besides, the appropriate supercritical fluid may be carbon dioxide supercritical fluid, nitrogen gas supercritical fluid and mixtures thereof.

### EXAMPLE

Polypropylene beads, which have a standard grade of copolymer resin (Pro-Fax EP3C37F) of a melt flow index of 0.5 g/10 min and of a density of substantially 0.91 g/cm³, are loaded through a feeding hopper into a twin-screw extruder. After the carbon dioxide supercritical fluid in an amount of substantially 5.0% corresponding to the melting body is injected from the screw side, it is immediately mixed with the polypropylene fluid to be a homogeneous single-phase mixture. And then, the homogeneous single-phase mixture is extruded through a sheet die to granulate foamed polypropylene beads each containing micro voids inside.

### Testing Result

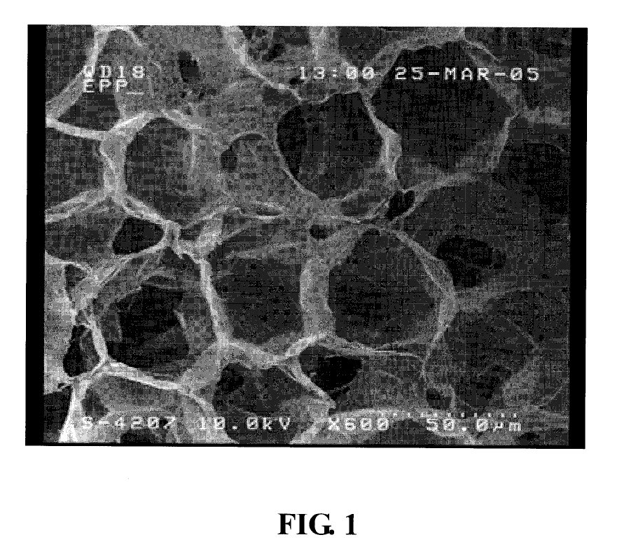

The mean sampling density is 0.04 g/cm³. The original density of the product of EXAMPLE is substantially 0.91 g/cm³. Therefore, the foaming efficiency of the product of EXAMPLE is substantially 22.75-fold. The mean cell diameter of the micro voids is substantially 50 μm, as shown in FIG. 1.

In comparison with the conventionally batch-type process of foamed polymer beads, the present method is to produce foamed polymer beads by using a continuous process, that is to say, it is simultaneously carrying out the immersing and foaming steps in the same extruder but in different segments thereof, thereby increasing the production efficiency and throughput efficiently.

As is understood by a person skilled in the art, the foregoing preferred embodiments of the present invention are merely illustrated of the present invention rather than limiting of the present invention. It is intended to cover various modifications and similar arrangements included within the spirit and scope of the appended claims. Therefore, the scope of which should be accorded the broadest interpretation so as to encompass all such modifications and similar structure.

What is claimed is:

1. A method of making foamed polymer beads, comprising:
mixing a polymer with a high-pressure gas or a supercritical fluid in an extruder to create a homogeneous single-phase mixture, wherein the polymer is selected from the group consisting of polyolefin, polyolefin copolymer, cyclic olefin, cyclic olefin copolymer, polystyrene, polystyrene copolymer, acrylic resin, polycarbonate and mixtures thereof, and
extruding the homogeneous single-phase mixture through a die to granulate forming foamed polymer beads each containing micro voids inside.

2. The method of making foamed polymer beads according to claim 1, wherein the micro voids have a mean cell diameter of no more than 200 μm, and the foamed polymer beads have a specific gravity of no more than 0.5.

3. The method of making foamed polymer beads according to claim 1, wherein the high-pressure gas is selected from the group consisting of carbon dioxide, nitrogen gas, hydrocarbon compounds, chlorofluorocarbon compounds and mixtures thereof.

4. The method of making foamed polymer beads according to claim 1, wherein the supercritical fluid is selected from the group consisting of carbon dioxide supercritical fluid, nitrogen gas supercritical fluid and mixtures thereof.
